(19) United States
(12) Patent Application Publication
(10) Pub. No.: US 2018/0014505 A1
(43) Pub. Date: Jan. 18, 2018

(54) PET WATER STATION

(71) Applicant: MacNeil IP LLC, Bolingbrook, IL (US)

(72) Inventors: David F. MACNEIL, Fort Lauderdale, FL (US); Frederick W. MASANEK, JR., Barrington, IL (US)

(73) Assignee: MacNeil IP LLC, Bolingbrook, IL (US)

(21) Appl. No.: 15/717,127

(22) Filed: Sep. 27, 2017

Related U.S. Application Data
(63) Continuation-in-part of application No. 15/467,160, filed on Mar. 23, 2017.
Application No. 15/467,160 is a continuation-in-part of application No. 15/089,863, filed on Apr. 4, 2016, now abandoned.

(51) Int. Cl. A01K 7/00; A01K 5/01

(52) U.S. Cl. CPC A01K 7/005; A01K 5/0135

(57) ABSTRACT

A top surface of an elevating stand of a pet water station defines a bowl receptacle into which an oblong water bowl may be removably installed. A foot of the stand is downwardly displaced from the top of the stand and has a foot locating surface. A mat of the station has a mat locating feature that extends upwardly from a general upper surface of the mat, and this mat location feature has a mat locating surface that reciprocally conforms to the foot locating surface. An antirotation feature of the mat intersects an arc on which the foot locating surface is disposed and is positioned adjacent an end of the stand foot, preventing rotation of the stand relative to the foot in at least a first predetermined angular direction. The bowl, bowl receptacle, stand foot, mat locating feature and antirotation feature coact to orient the oblong bowl in a predetermined angular orientation relative to the front of the pet water station.

### RELATED APPLICATIONS

This application is a continuation in part of copending U.S. patent application Ser. No. 15/467,160 filed Mar. 23, 2017, which in turn is a continuation in part of U.S. patent application Ser. No. 15/089,863, filed Apr. 4, 2016, now abandoned. These prior applications are owned by the Applicant hereof. The entire disclosure and drawings of these prior Applications are incorporated by reference herein.

### BACKGROUND OF THE INVENTION

A traditional way to feed a dog or a cat is to place a bowl of food and a bowl of water on the floor. More recently, pet feeding stations have been developed which elevate the food and water bowls off of the floor. This puts the food and water at a convenient height for the pet.

Dogs in particular can be messy eaters. The optimum pet feeding station or system is one that is easily accessible by the pet, is easy to clean and that generates a minimum of stray food and water. As a cat, or more particularly, a dog, eats, there may be a tendency for the food and water bowl to slide around; these quadrupeds usually do not hold their food or water bowls in place with their paws. A larger dog may be big enough to easily displace its food or water bowl with motions of its head alone. Because they are thus apt to be sources of stray food or water particles, pet feeding sites equipped with conventional containers sometimes attract unwanted pests.

Dogs in particular have elongated noses and mandibles. A traditional pet bowl has an interior surface that is shaped like a flattened hemisphere, providing a poor match to the shape of a typical dog's head. This makes eating incrementally more difficult for the dog and the mismatch in shape is apt to generate more stray food particles and water splashes. A need therefore exists for a pet feeding system that minimizes awkwardness or discomfort for the pet while at the same time contains and manages the detritus generated by a pet eating its dinner or taking a drink.

There are many situations in which a pet could use access to water but does not need food. For these situations, a pet water station could be devised that had only a single bowl, held at a comfortable distance for the pet in question above the floor, and having an oblong bowl that stays correctly oriented toward the pet.

### SUMMARY OF THE INVENTION

The invention presents a system for providing at least one of food or water to a pet. A stand of the system has a top with a bowl receptacle for receiving a food or water bowl. The system further includes a mat onto which the stand may be removably installed. A locating feature of the mat extends upwardly from a mat general upper surface. The mat locating feature has a mat locating surface formed at an angle to the mat general upper surface. The mat further has an antirotation feature that also extends upwardly from the general upper surface of the mat.

A foot locating surface of a foot of the stand is formed at an angle to the mat general upper surface. This foot locating surface reciprocally conforms to the mat locating surface when the stand is installed onto the mat. Interaction between the stand foot and the mat antirotation feature prevents rotation of the stand around a vertical axis in at least a predetermined angular direction. Interaction between the foot locating surface and the mat locating surface prevents lateral displacement of the stand relative to the mat in at least a predetermined direction.

In one embodiment, the mat has a second locating feature with a second mat locating surface and a second antirotation feature, and the stand further has a second stand foot with a second foot locating feature. The second foot locating surface reciprocally conforms to the second mat locating surface when the stand is installed on the mat. Respective interaction of the first and second mat locating surfaces with the first and second foot locating surfaces prevents lateral displacement of the stand relative to the mat in any direction. Interaction of the first antirotation feature with the first stand foot, and interaction of the second antirotation feature with the second stand foot, prevent angular displacement around the axis of the stand relative to the mat in either angular direction.

In one embodiment, the mat locating surface and the foot locating surface are surfaces of rotation around the vertical axis. The foot locating surface conforms to an arc. The antirotation feature intersects this arc so as to prevent rotation of the foot around the axis in one angular direction. In one embodiment, there is a second stand foot with a second foot locating surface that, when the stand is installed onto the mat, reciprocally conforms to a second mat locating surface. A second antirotation feature intersects a second arc to which the second foot locating surface conforms. The addition of the second foot locating surface, the second stand locating surface and the second antirotation feature provides resistance to lateral displacement of the installed stand relative to the mat in any direction, and ensures that the installed stand may not be rotated relative to the mat in either angular direction around the axis. In one embodiment, the bowl of the system is noncircular and is oriented to the front of the station in a particular way. The antirotation features of the mat help ensure that this angular orientation is maintained.

### BRIEF DESCRIPTION OF THE DRAWINGS

Further aspects of the invention and their advantages can be discerned in the following detailed description, in which like characters denote like parts and in which:

FIG. 1 is a top perspective view of a pet water station according to the invention, shown in assembled condition;

FIG. 1A is a drawing of a three-dimensional frame of reference used in describing the invention;

FIG. 2 is an exploded perspective view of the pet water station introduced in FIG. 1;

FIG. 3 is a top view of a bowl for use with the invention;

FIG. 4 is a schematic view of a bowl periphery taken in a top plane thereof, to show a possible bowl geometry;

FIG. 5 is a longitudinal sectional view of the bowl shown in FIG. 3;

FIG. 6 is a schematic side view of the bowl shown in FIGS. 3-5, showing the relationship of the bowl interior surface to the nose and jaw of a drinking dog;

FIG. 7 is a top rear perspective view of a stand used in the pet water station shown in FIG. 1;

FIG. 8 is a view similar to that shown in FIG. 7, but with the bowl installed;

FIG. 9 is a longitudinal sectional detail of the bowl as installed in the stand, taken through a finger notch of the stand;

FIG. 10 is a longitudinal sectional detail of the bowl as installed in the stand, taken through the front walls of the bowl and stand;

FIG. 11 is a top perspective view of a mat for use with the invention;

FIG. 12 is a longitudinal sectional view taken substantially along line 12-12 of FIG. 11;

FIG. 13 is a transverse sectional view taken substantially along line 13-13 of FIG. 11;

FIG. 14 is a horizontal sectional view taken through arcuate ribs of the mat and the feet of the stand when the stand is assembled to the mat;

FIG. 15 is a detail of FIG. 14;

FIG. 16 is a transverse sectional detail showing a stand foot and a locating arcuate mat rib; and

FIG. 17 is a top view of the assembled pet water station shown in FIG. 1.

### DETAILED DESCRIPTION

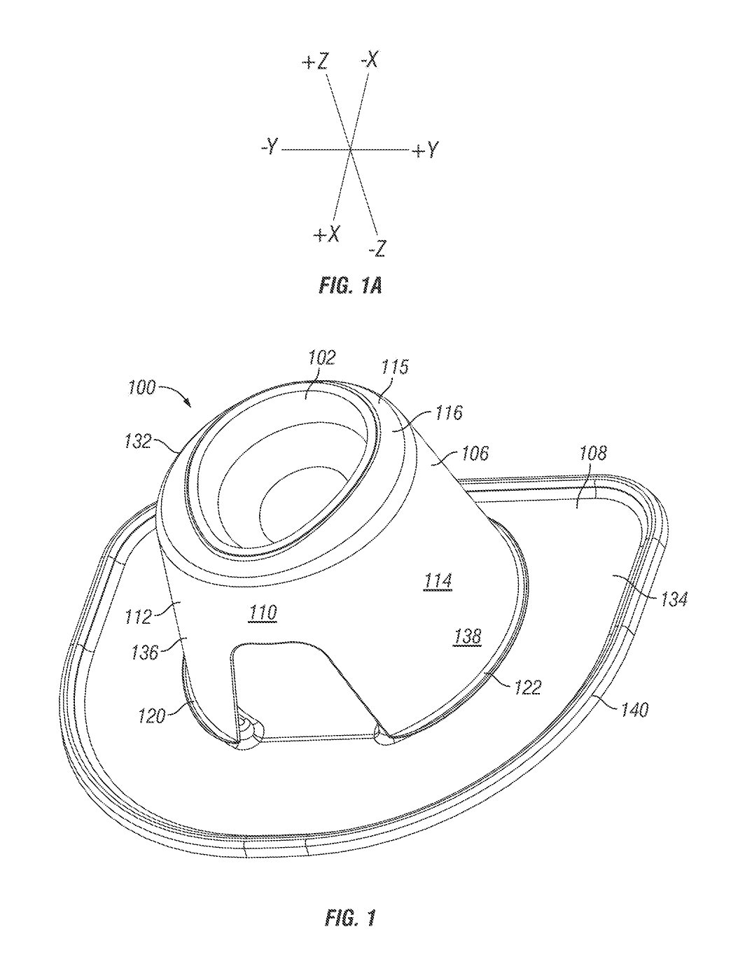

A system for providing food or water to a pet is generally indicated by 100 in FIG. 1. In this embodiment, the system 100 has three components: a bowl 102, a stand 106 and a mat 108. The illustrated embodiment includes only one bowl 102, which can contain food but in use will more likely be filled with water. The illustrated embodiment has particular use as a pet water station at a location remote from where the pet might otherwise take its meals. In other embodiments, there may be two or more bowls instead of the single bowl 102 shown.

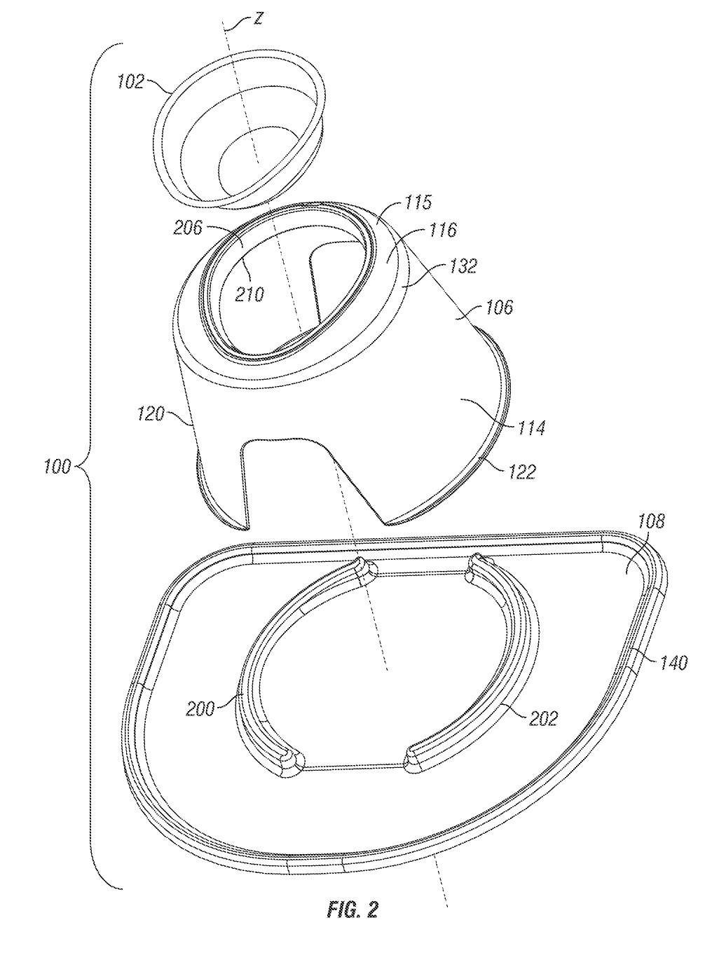

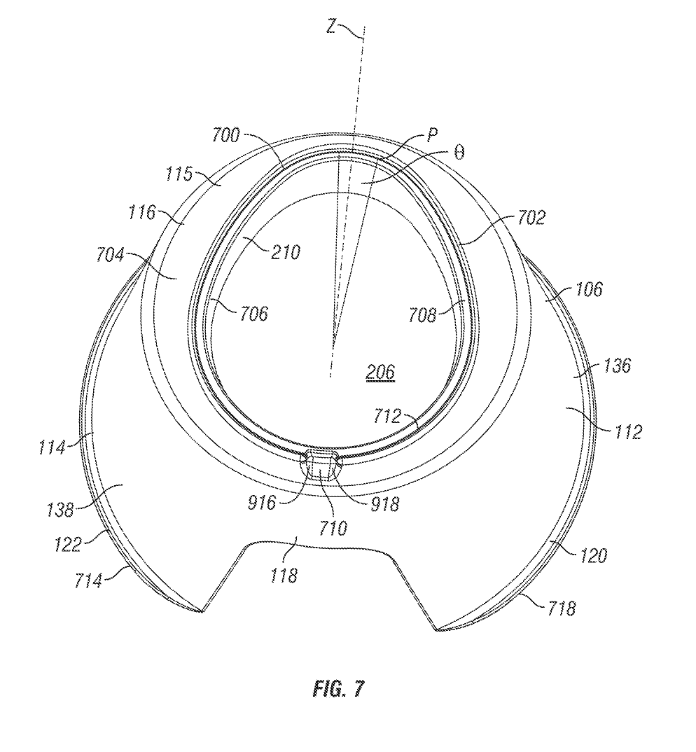

The stand 106 has a front or front wall 110 that is joined by a continuous curved wall to a left side 112 and by a continuous curved wall to a right side 114. Front 110 is convexly curved at its center. A top 115 is integrally molded with, and spans across, the front 110, left side 112 and right side 114. The stand top 115 has a stand top surface 116. The stand 106 further has a back or a rear side 118, shown for example in FIG. 7, to which the left and right sides 112, 114 are joined by respective continuously curved walls. The left side 112 and the right side 114 downwardly extend from the top 115 respectively to a left foot 120 and a right foot 122. In the illustrated embodiment, feet 120 and 122 are distinct and are spaced from each other in a “y”, transverse or width direction (see FIG. 1A) and are angularly spaced from each other around axis Z. In other embodiments, the feet 120, 122 may be continuous with each other and form a single base with an unbroken circumference, or may divided further, for example to create two distinct left legs and two distinct right legs (not shown). In the illustrated embodiment, any horizontal section of stand 106 between stand top 115 and stand feet 120, 122 will be circular. This creates an advantage for aesthetics but a disadvantage in that the stand 106 will be free to rotate about the station axis Z (see FIG. 2) unless otherwise restrained.

Bowl 102 may be stamped or formed from stainless steel and in one embodiment may be polished. More particularly, bowl 102 may be stamped from 300-series stainless steel, such as Type 301 or Type 304, and even more particularly may be stamped from Type 304 stainless steel, used for containers and implements for food for human consumption. Bowl 102 is thus easy to keep clean and won't harbor microbial contamination.

FIG. 1A depicts a frame of reference used in this specification. Direction +x is toward the front of the stand 106, while −x is toward the rear of the stand. Direction +y is at 90 degrees to direction x and is toward the right side of the stand 106, while direction −y is toward the left side. Direction+z, at ninety degrees to both directions x and y, is an upward vertical direction, while direction −z is vertically downward. An xy plane is horizontal, while xz and yz planes are vertical. The (+x, −x) axis (or X axis) is longitudinal or front-to-rear, the (+y, −y) axis is transverse or side-to-side, and the (+z, −z) axis (or Z axis) is vertical.

The stand 106 is preferably integrally injection molded of a tough thermoplastic polymer compound such as polypropylene or ABS and may have a textured exterior surface. The compound used to injection-mold stand 106 may include silver-based antimicrobial particles. Stand 106 may be molded in any of a range of colors.

The left foot 120 and right foot 122 define an area between them that is considerably smaller than the area of the upper surface 134 of the mat 108. A shoulder 132 of the stand top surface 116 is laterally interiorly spaced from the positions of the left and right feet 120, 122. A left sidewall 136 forming the left side 112 slopes downwardly and outwardly until it terminates in left foot 120, and a right sidewall 138 forming the right side 114 slopes downwardly and outwardly until it terminates in right foot 122. Walls making up front 110 and rear 118 are likewise sloped downwardly and outwardly from top surface shoulder 132. This provides greater lateral stability and better resistance against lateral forces placed on stand 106 by the pet.

The mat 108 may be injection-molded, preferably from a thermoplastic elastomer compound. As molded, the mat 108 may have a Shore A hardness in the range of 60 to 85. The mat 108 may be manufactured with an antimicrobial additive (such as ionic or particulate silver that is nontoxic to mammals) that will inhibit the growth of mold, fungus, algae or bacteria that otherwise could stain or cause odors. As an alternative to injection molding and in one embodiment, mat 108 could be thermoformed from a sheet of material having a substantially uniform thickness. Mat 108 may be molded in any of a range of colors. The mat 108 has a raised peripheral margin 140 that works to retain food particles and fluids.

The exploded view of FIG. 2 reveals structure on mat 108 that cooperates with the left and right feet 120, 122 to resist movement of the stand 106 on the mat 108 in any lateral direction. In the illustrated embodiment, this structure consists of a pair of raised location features 200 and 202, which more specifically can be elongate ribs that are formed as a pair of arcs that are concave relative to the Z axis of the station 100. The bowl 102 is received in a bowl receptacle 206 defined in the stand top surface 116; in this embodiment the receptacle 206 is an opening or hole in the stand top 115. The bowl opening 206 is noncircular, and has a curved perimeter and a front-to-back diameter, as drawn at a right angle to axis Z, that is greater than a side-to-side diameter drawn at a right angle axis Z. The bowl opening 206 may be provided by a wall 210 that downwardly depends from the stand top surface 116. The bowl 102 is noncircular, has a shape that mates with bowl opening 206, and may be easily removed by hand for cleaning or filling and manually reinstalled in opening 206. Likewise, the stand 106 may be easily lifted off of mat 108 for cleaning and then located back onto mat 108 with the aid of arcuate locating ribs 200, 202.

In the illustrated embodiment, and as assembled, the bowl 102, stand 106 and mat 108 are all disposed on vertical axis Z.

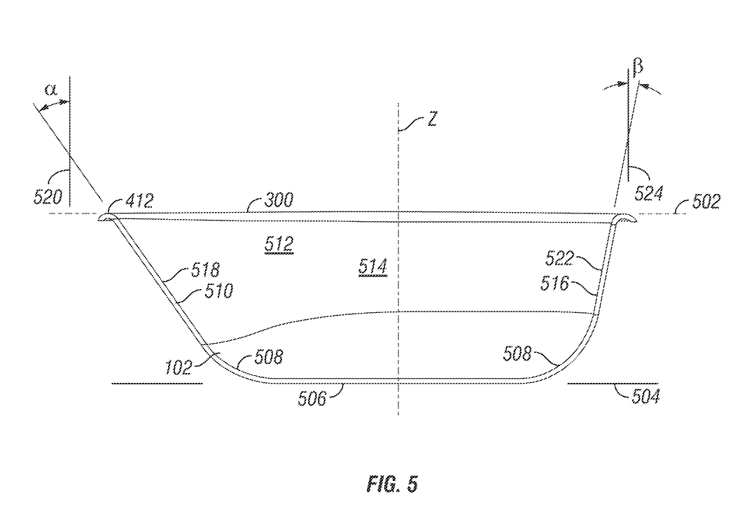

Details of a representative bowl 102 are shown in FIGS. 3, 4 and 5. The bowl 102, as installed in the stand 106, will extend between a horizontal or top plane 502 and a bowl bottom plane 504. A bowl upper edge or limit 300 is in the top plane 502. A radius r₁ from axis Z to bowl upper edge 300, in a +x direction, will be considerably greater than a radius r₃ from axis Z to upper edge 300 in either y direction. Radius r₁ will also be significantly greater than a radius r₂ drawn from axis Z in a (−x) direction to the rear of the stand, as shown. Radii r₁, r₂ and r₃ are all drawn in xy plane 502 (FIG. 5). The bowl 102 basically is lobed toward its front. Radius r₁ gradually decreases to radius r₃ as a function of angular displacement away from the +x direction. Radii r₂ and r₃ may be substantially similar.

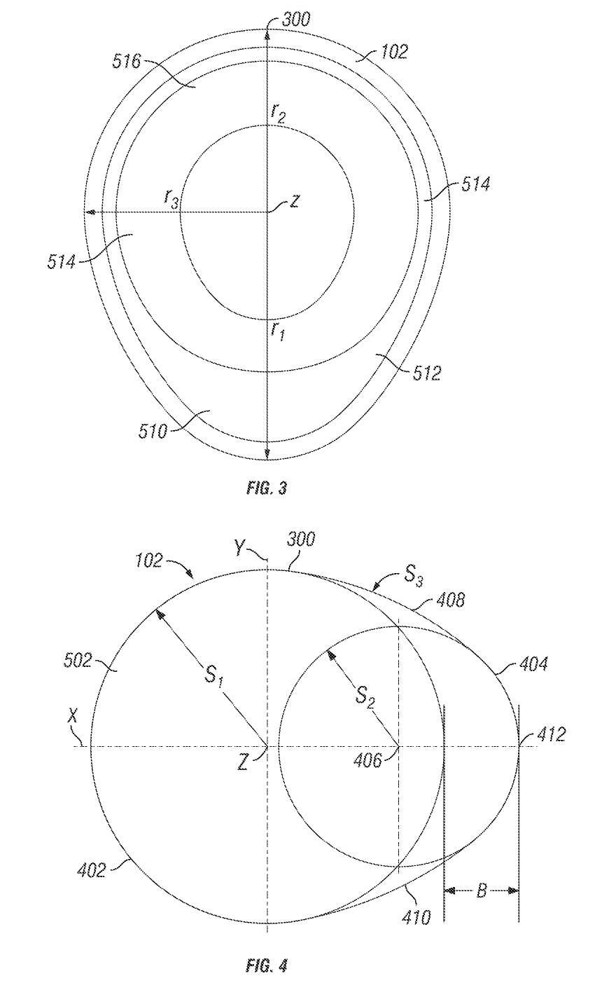

One shape of the bowl 102 may be arrived at as follows. FIG. 4 is a schematic plan view of periphery 300 of a bowl 102, as it appears at top plane 502. At top plane 502, the bowl periphery 300 may be a composite of three sets of curves: a circular segment 402 that is disposed at a radius S₁ from the Z axis; a circular segment 404 that is drawn around a second center 406, and at a radius S₂ therefrom; and two circular segments 408, 410 that each connect an end of circular segment 402 to a respective end of circular segment 404. Segments 408 and 410 each have a radius S₃ (not shown) around respective third centers that do not appear in FIG. 4. Radius S₂ may be chosen to be ⅔ of radius S₁. Radius S₃ may be chosen to be twice radius S₁. Bulge B, being the displacement of a frontmost point 412 of periphery 300 from the end of radius S₁ along the X axis, may be chosen as 0.4S₁.

The bottom 506 (FIG. 5) of the bowl 102 is initially drawn as a circle (not shown) around axis Z, at a radius that is smaller than S₁. The sides of the bowl are then lofted from periphery 300 to the bottom bowl circle. The bowl shape is then radiused at a constant radius at its bottom to produce the curved transitions 508 and the shape that is seen in FIGS. 3, 5 and 6.

As installed in the bowl opening 206, in the illustrated embodiment the longest radius (r₁) of the bowl 102 will extend from axis Z in the +x direction.

The bottom 506 of the bowl 102 may be flat, as shown, to aid in stability while filling. A front portion 510 of the curved interior surface 512 has a more gradual draft than does a side portion 514 or a rear portion 516. In the illustrated embodiment, an xz section of the front portion 510, as including axis Z, includes a straight segment 518. This straight segment 518 makes an angle α with respect to a vertical reference 520. An xz section of the rear portion 516, as including axis Z, includes a straight segment 522. Straight segment 522 makes an angle β with a vertical reference 524, with α>β. A yz section (not shown) of the side portion 514, as including axis Z, would include a straight segment that makes an angle γ with a vertical reference, with α>γ. Angles β and γ may be similar to each other. Straight segments 518, 522, and the curved surfaces of which they are a part, may be joined to the bottom 506 by curved transitions 508. In alternative embodiments, one or more of the straight segments 518, 522 may be replaced by curves. Nonetheless, as taken in any particular horizontal plane, the slope of the front portion 510 will remain gentler than the slopes of the side portions 514 or rear portion 516.

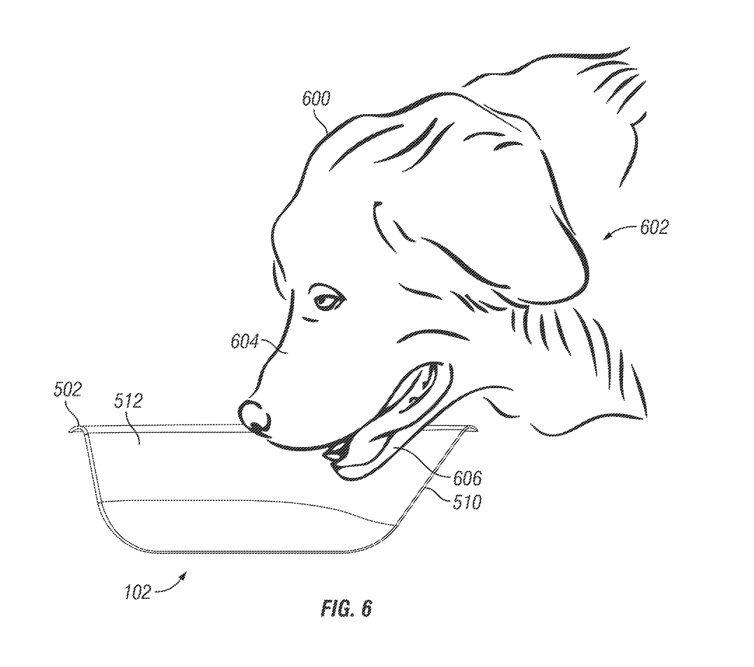

FIG. 6 depicts the relationship of a representative bowl 102, here shown in an xz sectional view, and the head 600 of a dog 602. Dog 602, as is typical of most breeds, has a pronounced nose 604 and jaw 606. When dog 602 wants to eat or drink from bowl 102, it will insert its jaw 606 and nose 604 into the bowl 102. The gradual draft of the front portion 510 of the bowl interior surface 512 makes this easy for the dog to do. And because a good portion of the dog's nose 604 and jaw 606 are below bowl top plane 502, the escape of food particles and water out of bowl 102 is reduced.

Another technical advantage of the invention derives from the provision of a noncircular bowl 102, for removable installation into a noncircular opening or receptacle 206 in stand 106. Dogs in particular make extensive use of their tongues while feeding and little or no use of their paws. A dog often will lick the internal surface of the bowl 102, often imparting a considerable amount of force to the bowl. If the bowl 102 and opening 206 were circular, the licking action of the dog would cause the bowl to spin within the bowl receptacle, having a tendency to eject food or water particles and also tending to encourage the inadvertent separation of the bowl from the stand 106. The noncircularity of the bowl 102 and its bowl receptacle 206 prevents this, and keeps the extended front lobe of each bowl 102 oriented toward the front of the stand 106 and toward the pet.

The bottom of bowl 102 resides in a bottom plane 504 (FIG. 5) that, in this embodiment, is elevated by a considerable distance above the mat 108. Pet water stations 100 can be made in various sizes, in which the size of the bowl 102 and its height above mat 108 can be independently altered.

Referring to FIG. 1, The stand 106 is outwardly splayed in x, −x and y, −y directions to give it greater stability and resistance against lateral forces. The mass of the preferably stainless steel bowl 102 and its contents will be well inward from the stand side walls 110, 118, 136 and 138. The inclined side walls 110, 118, 136 and 138 are braced to withstand shear forces in any lateral direction, and are formed as a continuous substantially frustoconical sheet of molded material around axis Z.

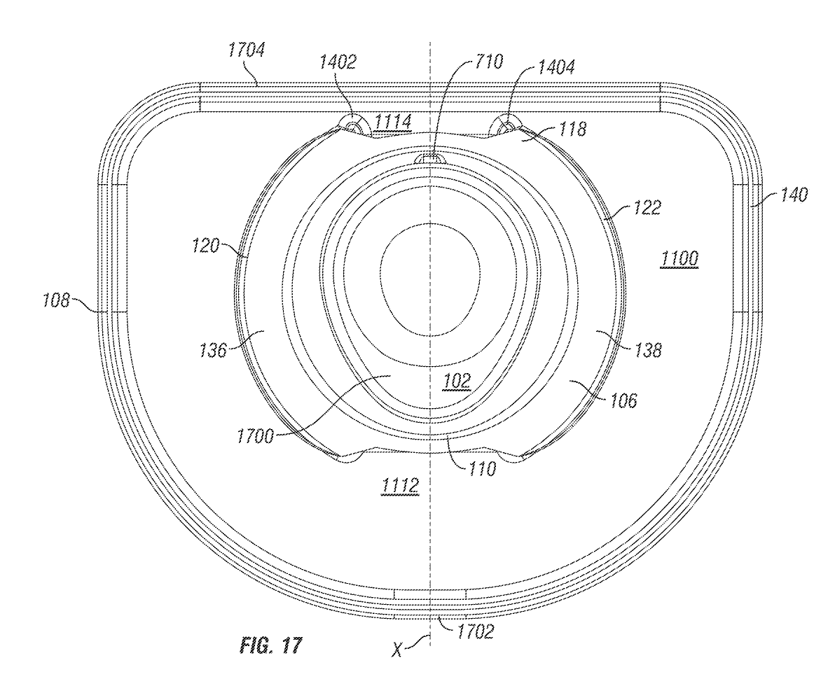

As best seen in FIG. 17, a total area of the mat 108 is much larger than an area taken up by or located between the stand feet 120 and 122. The stand 106 is sited well to the back of the center of mat 108. A rear region or area 1114 of mat 108 extends rearwardly from the back 118 of the stand 106 to a rear margin 1704 of mat 108. Margin 1704 can be straight for placement against a wall. A front region or area 1112 of mat 108 extends forwardly from the front wall 110 of the stand 106 to a front margin 1702 of the mat 108. Front margin 1702 can be convexly curved. Regions 1112, 1114 are extensive enough to catch most stray food or water. But front region 1112 is considerably larger than region 1114, so that it can accommodate the front paws of a drinking or feeding pet (not shown). The convexly curved shape of mat front margin 1702 also helps in this regard.

The mat back margin 1704 is meant to be positioned remotely or away from the pet, while the front margin 1702 is meant to be positioned to be proximate to and below a portion of the pet.

As seen in FIGS. 7-10, in the illustrated embodiment the stand top surface 116 has first, second and third zones 700, 702 and 704. The first zone 700 is disposed to be adjacent to, or include, an upper periphery 706 of bowl receptacle 206 and includes an upwardly convex ring 708 that completely laterally surrounds bowl receptacle 206. Extending laterally outwardly (relative to vertical axis Z of the receptacle and bowl) from the first zone 700 is the second zone 702. The second zone 702 of the top surface is either horizontal (perpendicular to axis Z) or is radially outwardly and downwardly sloped. In the illustrated embodiment, and in the near vicinity of the locus of contact by bowl edge 910, second zone 702 is flat and horizontal but from there begins to slope outward and downward.

The second zone 702 completely laterally surrounds the first zone 700, except where zone 702 is interrupted by a finger notch 710. As best seen in FIG. 10, the elevation of the top surface 116 of stand top 115 within second zone 702 is less than an upper limit 712 of the upwardly convex ring 708.

Disposed radially outwardly from the second zone 702 is a third zone 704. The slope of third zone 704 may increase as a function of the distance from axis Z, but any point on it slopes radially outwardly and downwardly relative to axis Z, so that water or food particles are easily shed off of zone 704 and not retained. Stand sides 112, 114 and connecting back 118 (and the opposed front 110, see FIGS. 1 and 2) each make a preferably curved shoulder 132 with a lower end of third zone 704.

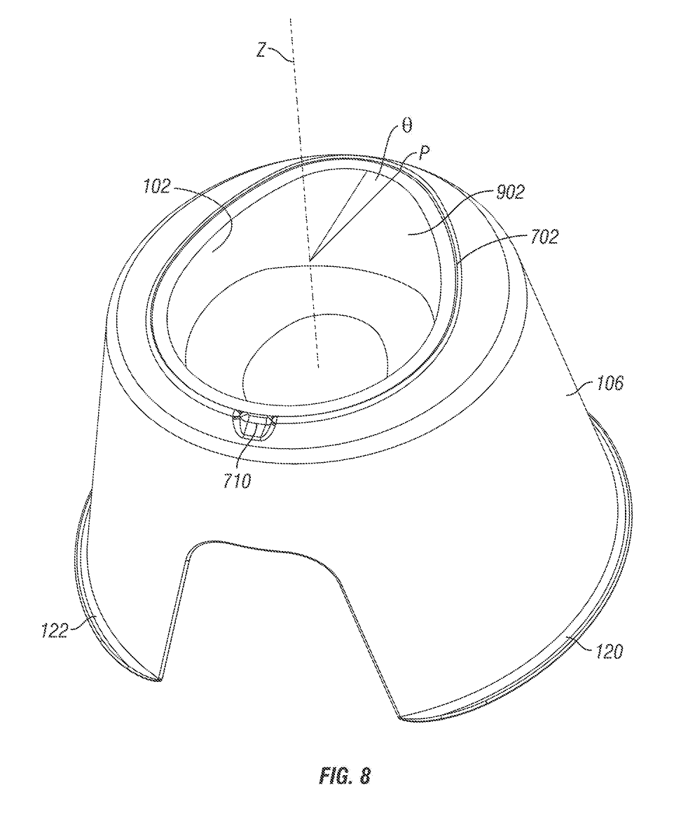

FIGS. 8, 9 and 10 all show a bowl 102 removably installed in the bowl receptacle 206 (the view of FIGS. 7 and 8 being from the top rear). From the upper periphery 706 of the bowl receptacle 206, and as extended from an inner wall of the convex ring 708, a sloped bowl receptacle sidewall 210 extends downwardly and radially inwardly to its lower and inner end 900. In this embodiment, inner end 900 is free, leaving an opening in the receptacle from the stand top 115 to the mat 108. In other embodiments, receptacle 206 may be a closed concave shape.

Relative to a vertical reference, and at any particular point P at a horizontal angular location θ as measured around receptacle and bowl axis Z, and in a given horizontal plane, the slope of sidewall 210 will subtend an angle φ_{R}. At this horizontal angular location and in the same horizontal plane, a sidewall 902 of the bowl 102 will subtend an angle φ_{B} relative to a vertical reference that is substantially similar to, but slightly gentler than, angle φ_{R} at that location. Said another way, the draft of the bowl sidewall 902 is slightly more pronounced than a corresponding draft of the bowl receptacle sidewall 210 at any given angular location. The difference between φ_{B} and φ_{R} may be chosen to be in the range of ½ to 2 degrees and in one embodiment is about 1 degree.

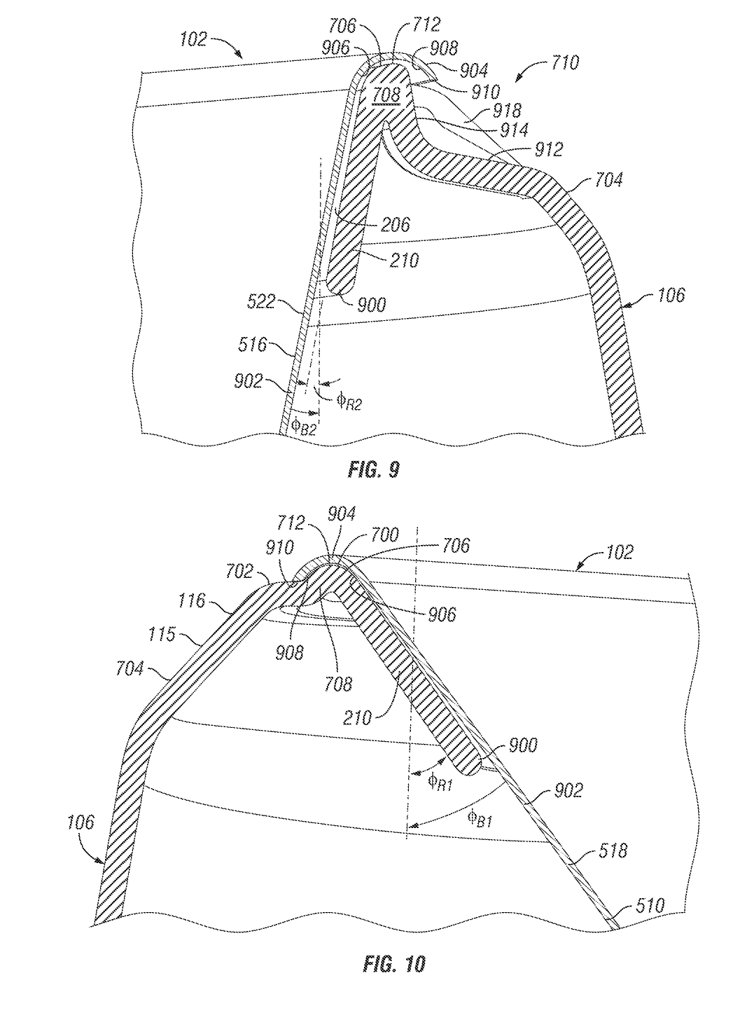

As taken in any given horizontal plane, the slopes of bowl sidewall 902 and bowl receptacle sidewall 210 vary as a function of horizontal angle θ from the axis. FIG. 10 is a section taken where θ=0°, or at the front of the stand 106, while FIG. 9 is a section taken where θ=180°, at the rear of the stand 106. As can be seen, φ_{B1}, taken at the front 510 of the bowl 102, is much larger/gentler than φ_{B2}, taken at the rear 516 of the bowl 102; the bowl 102 has a much shallower draft toward its front than its rear. The receptacle sidewall angles φ_{R1} and φ_{R2} vary in a conforming way so that they are substantially similar to, but slightly steeper than, the bowl angles taken at the same points. The gap between the bowl sidewall 902 and the bowl receptacle sidewall 210 increases with depth. In one embodiment, the gap is about 0.025 in. at the top of walls 210, 902, and is about 0.045 in. near wall end 900.

As best seen in FIGS. 9 and 10, a peripheral lip 904 of the bowl 102 has a lower surface 906 that is finished in a downwardly concave ring 908. A radius of the concave ring 908 is chosen to be slightly larger than a radius of the upwardly convex ring 708 of the stand top surface first zone 700. In this way, the concave ring 908 fits over and is slightly spaced from the convex ring 708. An outer edge 910 of peripheral lip 904 preferably contacts or rests on the top surface second zone 702 throughout most of the circumference of second zone 702, that is, throughout most of the circumference of the lip 904. This supports the entire weight of bowl 102. The nominal spacing (e.g., 0.020″) of the concave ring 908 from the convex ring 708 ensures that lip edge 910 will contact second zone 702, minimizing any gaps between them. As installed, the outer edge 910 is lower than an upper limit 712 of the convex ring 708. The interaction of the lower surface 906 of the downwardly concave ring 908 with the upwardly convex ring 708 aids in centering and seating the bowl, and makes harder the possible dislodgment of the bowl 102 from the bowl receptacle 206 by the pet.

As best seen in FIG. 9, the finger notch 710 interrupts and cuts through the second zone 702 of top surface 116 but not through the convex ring 708. The finger notch 710 has a slightly inwardly and upwardly sloped floor 912 that inwardly extends from a point on the third zone 704 to an inner notch wall 914. Notch floor 912 is lower in elevation than second zone 702 of the top surface 116; in one embodiment, it can be 0.32 inches deeper than second zone 702 as measured at the inner wall 914. The inner notch wall 914 is angled steeply upward and joins the notch floor 912 to the convex ring 708, via appropriate curved transitions. Inner notch wall 914 may be continuous with an outer wall of the convex ring 708, as shown. The notch 710 has a sharply upwardly sloped left side wall 918 that joins a left end of the notch floor 912 to the top surface 1166 of the stand top 115. Notch 708 is completed by a sharply upwardly sloped right side wall 916 (FIG. 7) that joins a right end of the notch floor 912 to the top surface 116 of the stand top 115.

The finger notch 710 permits a pet owner to insert a second, third or fourth finger of the hand underneath edge 910 of the bowl 102, such that bowl lip 904 may be grasped between the inserted finger and the thumb of the owner and the bowl 102 lifted from the bowl receptacle 206. Finger notch 710 is dimensioned so as to accomplish this purpose; the spacing between a top end of right sidewall 916 from a top end of left sidewall 918 may be about one inch. The floor and all walls of the finger notch 710 are radially outwardly and downwardly sloped for drainage. Importantly, the notch 710 does not open onto or continue into the interior of the bowl receptacle 206; the notch inner wall 914 joins to the convex ring 708 to provide a fluid-obstructing barrier all of the way around the periphery of the bowl receptacle 206.

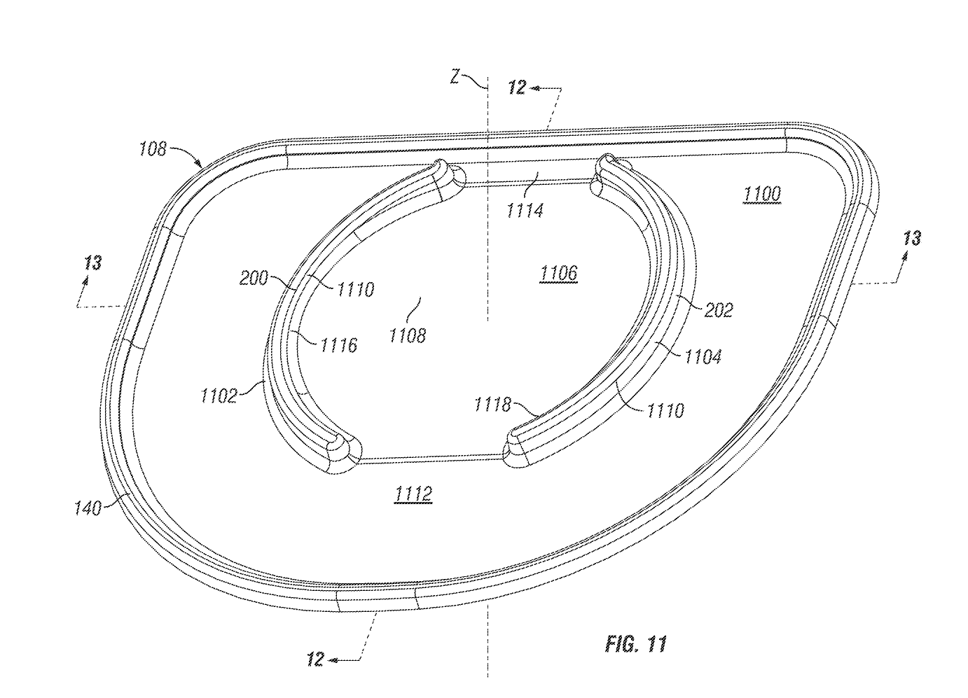

An area mat 108 for use with the invention is shown in FIG. 11. In the illustrated embodiment, each mat locating feature or rib 200, 202 extends upwardly from a general upper mat surface 1100 and conforms to an arc around axis Z. Each rib 200, 202 has an exterior frustoconical surface 1102, 1104 that is meant to reciprocally conform to a respective one of a pair of stand locating surfaces as described below. The ribs 200, 202 are angularly and transversely spaced from each other.

As seen in FIG. 7, a right stand sidewall 138 extends from the stand top 115 to a right stand foot 122. The right stand foot 122 has as a bottom flange 714 that radially outwardly extends from the bottom end of foot 122. Similarly, the left stand sidewall 136 extends from the stand top 115 to a left stand foot 120. A left bottom flange 718 extends radially outwardly from the bottom of left foot 120.

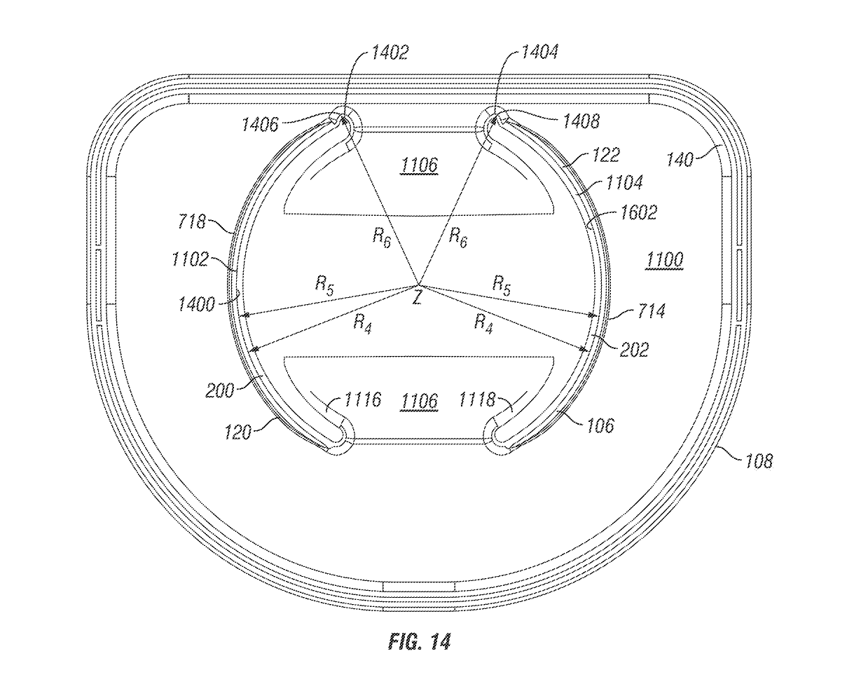

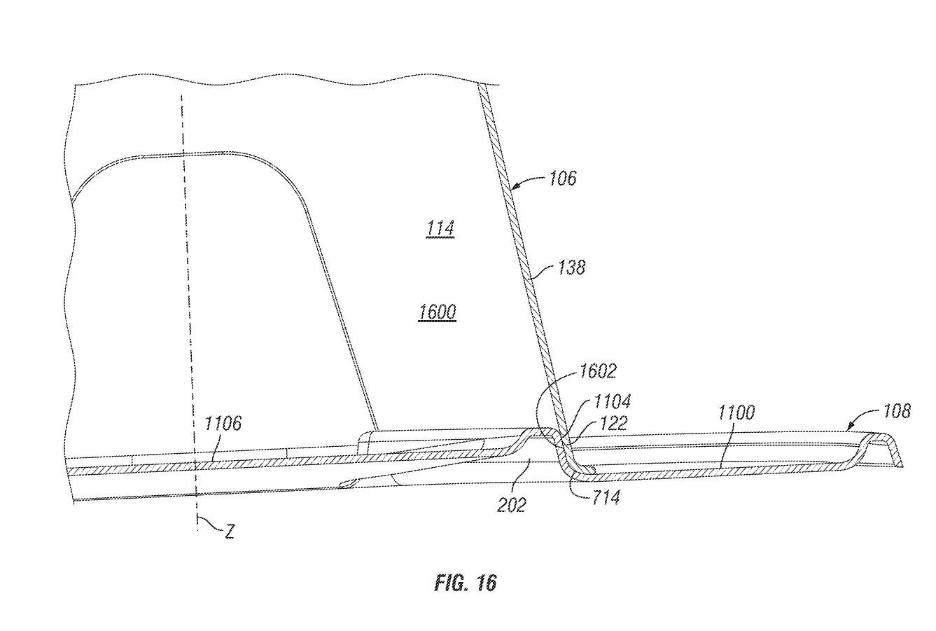

FIG. 16 shows how right stand foot 122 fits onto right mat rib 202; the relationship of left stand foot 120 to the left rib 200 is a mirror image of this view. The right sidewall 138 has a frustoconical interior surface 1600 that is continuous with an inwardly concave foot locating surface 1602. A lower end of the foot locating surface 1602 makes a curved transition to a bottom surface of flange 714. The foot locating surface 1602 reciprocally conforms to the outer, convex, frustoconical mat locating surface 1104 of the rib 202. In the illustrated embodiment, mat locating surface 1104 and foot locating surface 1602 are surfaces of rotation around axis Z. In the illustrated embodiment, all locating surfaces 1102, 1400 (see FIG. 14); 1104, 1602 slope upwardly and inwardly with respect to axis Z.

Ribs 200, 202 thus are raised features that cooperate with nonhorizontal surfaces of stand feet 122, 120 to prevent movement of the stand 106 in any lateral direction; a vector component of at least one of arcuate locating surfaces 1102, 1104 will resist movement in x, −x, y or −y directions or a direction which is any combination thereof. Structure alternative to that shown could do the same job. For example, instead of independent ribs 200, 202, mat 108 could have a mesa that stretches between them but that still has lateral exterior arcuate surfaces 1102, 1104. The ribs 200, 202 could be of shapes other than arcs, which then would cooperate with internal wall surfaces 1600 (one shown) that would have complementary shapes. It is also possible to break up each rib 200, 202 into spaced-apart segments or individual columns.

One advantage of ribs 200, 202 as they appear in the illustrated embodiment is that it is easy to clean them and the area in between them. Another advantage is that, once the stand feet 122, 120 have been lowered in place on top of them, most of the ribs 200, 202 will be visually obscured and largely will be sheltered from falling fluid or food particles, as is seen in FIGS. 1 and 17. For these reasons, it is preferred to have the mat locating structure 200, 202 laterally interior to the stand walls 136, 138 instead of laterally exterior to them. In the illustrated embodiment, side walls 136 and 138, and their curved transitions to front and back walls 110, 118, subtend arcs that are enough larger than the arcs of ribs 200, 202 that the latter can be seen only with difficulty once system 100 is assembled.

In a preferred embodiment, and referring to FIG. 14, the arc subtended by rib exterior surface 1104 should be only slightly less than the arc subtended by inner foot surface 1602. Similarly, the arc subtended by rib exterior surface 1102 should be only slightly less than the arc subtended by left foot locating surface 1400. This insures maximum contact for support, but also minimizes gaps that could cause food or water particle trapping.

FIG. 14 is a horizontal section of mat 108 and stand 106 as assembled to it, taken in a plane upwardly displaced from and parallel to the substantially planar general upper surface 1100 of the mat 108. A variety of structures that extend upwardly from general upper surface 1100. Among these is the raised peripheral margin 140, two mat locating features 200, 202 that in the illustrated embodiment take the form of arcuate ribs, and two antirotation features 1402 and 1404. Antirotation features 1402 and 1404 prevent the rotation of stand 106 around axis Z relative to mat 108, in either angular direction; antirotation feature 1402 prevents such rotation in a clockwise direction, and antirotation feature 1404 prevents such rotation in a counterclockwise direction.

In this embodiment, and as considered in the horizontal sectional plane shown, the right mat locating surface 1104 is disposed at a constant radius R₄ from axis Z. Left mat locating surface 1102 likewise is disposed at radius R₄. Left foot locating surface 1400, which reciprocally conforms to left mat locating surface 1102, is at an only slightly greater radius R₅ from axis Z. Right foot locating surface 1602, which reciprocally conforms in its shape to right mat locating surface 1104, likewise is at radius R₅. A far margin 1406 of left antirotation feature 1402 is the most radially remote portion of feature 1402 from axis Z and is at a radius R₆ from axis Z. Likewise, a radial far margin 1408 of right antirotation feature 1404 is positioned at radius R₆ from axis Z. Radius R₆ is sufficiently greater than radius R₅ that the antirotation feature 1402 will physically interfere with the clockwise rotation of left foot 120, and antirotation feature 1404 will physically interfere with the counterclockwise rotation of right foot 122.

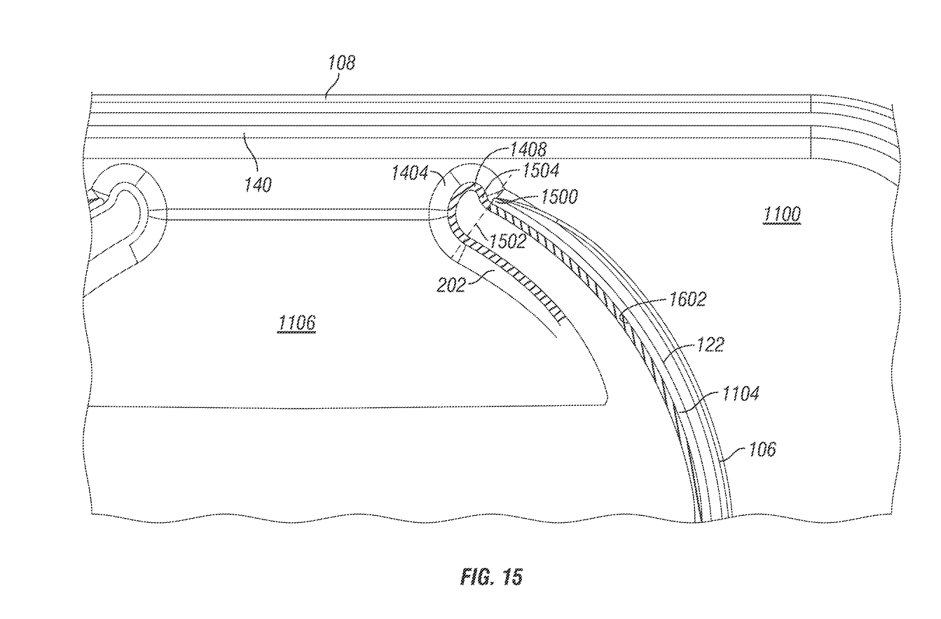

As best seen in the detail shown in FIG. 15, and taking the right foot 122 and right antirotation feature 1404 as an example, the right foot 122 has an end 1500, at which its foot locating surface 1602 also terminates. The mat locating feature or rib 202 has an end 1502, at which the mat locating surface 1104 terminates. In the illustrated embodiment, the antirotation feature 1404 is formed as a thickened knob that is continuous with rib end 1502; alternatively the antirotation feature 1404 could be formed to be discontinuous with rib 202. The antirotation feature 1404 thus presents a wall 1504 that intersects the circular path or arc on which foot 122 will attempt to travel if it is urged in a counterclockwise direction. In this way, foot 122, and the stand and bowl connected to it, are prevented from rotating counterclockwise. Antirotation feature 1402 has a similar morphology and presents a wall that intersects the circular path or arc on which foot 120 will attempt to travel if it is urged in clockwise direction. In this way, foot 120, and the stand and bowl connected to it, are prevented from rotating clockwise. As assembled to the mat 108, the stand 106 and the bowl 102 are therefore locked in a predetermined angular orientation.

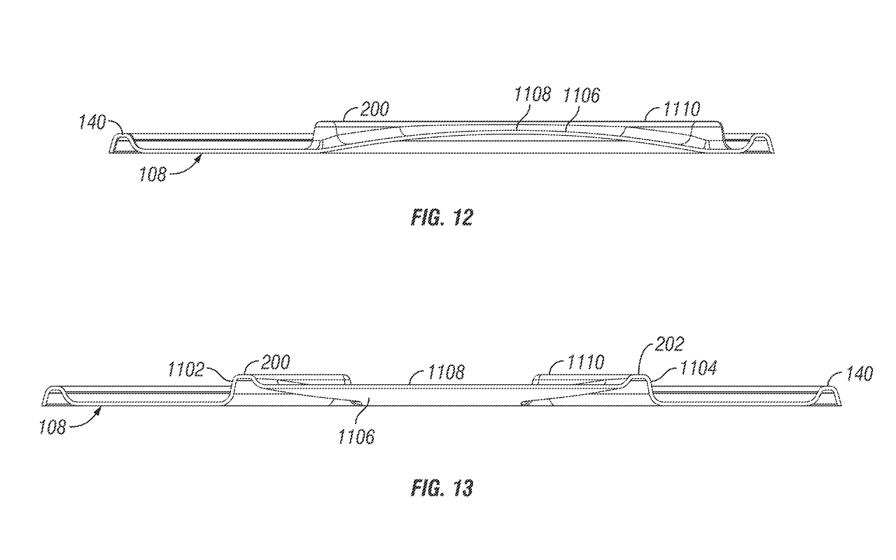

In the illustrated embodiment, instead of the area between ribs 200, 202 being flat, and as seen in FIGS. 11-13, an area 1106 is vaulted or barrel-shaped, with an axis of the “barrel” being in a y direction. A top 1108 of the vault 1106 can be at the same height as the top 1110 of ribs 200, 202, but in the illustrated embodiment the maximum elevation 1108 of the vault 1106 is lower than the height of ribs 200, 202. In operation, when fluid or particulate matter drops on vaulted surface 1106, it will tend to flow or roll downhill and out onto peripheral areas 1112, 1114 (FIG. 17). Providing the vaulted surface 1106 also decreases the surface area of internal facing surfaces 1116, 1118 of ribs 200, 202 (FIG. 11). That decreases the amount of surface that can accumulate bacteria and the like and decreases the amount of surface that needs to be cleaned. In embodiments alternative to the one illustrated, the vaulted surface 1106 may be supported with a plurality of ribs that downwardly extend from the vaulted surface 1106 to be supported by the floor.

The mat 108 preferably is injection-molded and its various parts are formed by walls that at least roughly conform to a nominal thickness for ease in molding. In such an embodiment, ribs 200, 202 are hollow.

As seen in FIG. 17, the bowl 102 has a front lobe 1700 that should be oriented along front-to-rear axis X to face the front 1702 of the mat 108. This predetermined bowl/mat angular orientation is obtained by the interaction of the noncircular shape of bowl 102 and the matching noncircular shape of bowl receptacle 206 (FIG. 2), in combination with the interaction of antirotation feature 1402 with left stand foot 120 and the interaction of antirotation feature 1404 with right stand foot 122. The resultant frontal presentation of bowl 102 to the pet maximizes the benefit obtained from its oblong shape.

In summary, an improved pet water station incorporates a bowl with a forwardly extending portion and a gradual draft to easily accommodate the head of a drinking pet. A top surface of the stand is crowned to shed stray water or food particles. A mat of the station has location and antirotation features that locate the stand and hold it in place against lateral shear and torsional forces. A convex ring surrounds a bowl receptacle of the stand to allow for easier indexing and location of the bowl to the stand and makes harder the dislodgement of the bowl from the stand by the pet. A finger notch is provided adjacent each bowl receptacle so that a user may more easily remove the bowl from the stand for filling or cleaning.

While illustrated embodiments of the present invention have been described and illustrated in the appended drawings, the present invention is not limited thereto but only by the scope and spirit of the appended claims.

We claim:

1. A system for providing at least one of food and water to a pet, the system comprising:
a bowl for receiving food or water;
a stand having a top, a bowl receptacle formed in the top for receiving the bowl, a stand foot of the stand downwardly displaced from the top of the stand, the stand disposed on a vertical axis;
a mat onto which the stand may be removably installed, the mat having a general upper surface orthogonal to the axis and a mat locating feature upwardly extending from the general upper surface, the locating feature having a mat locating surface formed at an angle to the general upper surface, the mat having an antirotation feature upwardly extending from the general upper surface; and
a foot locating surface of the stand foot formed at an angle to the general upper surface of the mat, the foot locating surface reciprocally conforming to the mat locating surface when the stand is installed onto the mat, interaction between the stand foot and the antirotation feature of the mat preventing rotation of the stand around the axis in at least a predetermined angular direction, interaction between the foot locating surface and the mat locating surface preventing lateral displacement of the stand relative to the mat in at least a predetermined direction.

2. The system of claim 1, wherein the locating feature of the mat is a first locating feature, the mat locating surface is a first mat locating surface, the antirotation feature is a first antirotation feature, the stand foot is a first stand foot and the foot locating surface is a first locating surface, the mat further having a second locating feature with a second mat locating surface and a second antirotation feature, the stand further having a second foot with a second foot locating surface, the second foot locating surface reciprocally conforming to the second mat locating surface when the stand is installed onto the mat, interaction of the first and second mat locating surfaces with the first and second foot locating surfaces preventing lateral displacement of the stand relative to the mat in any direction, interaction of the first antirotation feature with the first stand foot and the second antirotation feature with the second stand foot preventing angular displacement around the axis relative to the mat in either angular direction.

3. The system of claim 1, wherein the bowl is a noncircular bowl, the bowl receptacle being a noncircular bowl receptacle so as to receive the noncircular bowl in only a single angular orientation with respect to the axis, the mat having a predetermined front, the noncircular bowl receptacle of the stand, the stand foot, and the antirotation feature of the mat coacting to orient the noncircular bowl to the front of the mat in a predetermined angular bowl/mat orientation.

4. The system of claim 3, wherein the noncircular bowl has a front lobe, the front lobe of the noncircular bowl oriented to the front of the mat when the noncircular bowl and the mat are in the predetermined angular bowl/mat orientation.

5. The system of claim 1, wherein only one bowl receptacle is formed in the top of the stand, the bowl and the bowl receptacle disposed on the axis.

6. The system of claim 1, wherein the stand foot terminates a sidewall extending between the top of the stand and the stand foot, the stand foot including a foot flange that extends laterally outwardly relative to the axis from the sidewall.

7. The system of claim 1, wherein the mat locating feature is disposed radially inwardly of the stand foot relative to the axis.

8. A system for providing at least one of food or water to a pet, the system comprising:
a stand disposed on a vertical axis and having a top, a bowl receptacle formed in the top, a stand foot downwardly displaced from the top, the foot having a foot locating surface formed as a surface of rotation around the axis, the foot locating surface conforming to an arc around the axis and having an end;
a mat onto which the stand may be removably installed, the mat disposed on the axis and having a general upper surface substantially orthogonal to the axis, a mat locating feature of the mat upwardly extending from the general upper surface and having a mat locating surface at an angle to the general upper surface, the mat locating surface formed as a surface of rotation around the axis, the foot locating surface reciprocally conforming to the mat locating surface when the stand is installed onto the mat; and
an antirotation feature of the mat upwardly extending from the general upper surface of the mat, the antirotation feature disposed adjacent the end of the foot locating surface so as to intersect the arc and prevent rotation of the stand around the axis in at least a predetermined angular direction.

9. The system of claim 8, wherein the antirotation feature of the mat is continuous with the mat locating feature of the mat.

10. The system of claim 8, wherein the mat locating surface and the foot locating surface are substantially frustoconical surfaces.

11. The system of claim 8, wherein the mat locating surface and the foot locating surface are upwardly and inwardly sloped relative to the axis.

12. The system of claim 8, wherein the mat locating feature is an elongate, hollow arcuate rib, the mat locating surface being an outer sidewall of the rib relative to the axis.

13. The system of claim 8, wherein an arcuate stand sidewall extends from the top of the stand to the stand foot, the foot locating surface being, relative to the axis, an interiorly facing surface of the arcuate stand sidewall.

14. The system of claim 8, wherein the stand foot is a first stand foot, the foot locating surface is a first foot locating surface, the mat locating feature is a first mat locating feature, the mat locating surface is a first mat locating surface and the antirotation feature is a first antirotation feature, the system further comprising a second stand foot downwardly displaced from the top of the stand and having a second foot locating surface formed as a surface of rotation around the axis, the second foot locating surface conforming to a second arc around the axis and having a second end, the mat having a second locating feature upwardly extending from the general upper surface of the mat, a second mat locating surface of the second mat locating feature formed as a surface of rotation around the axis and to reciprocally conform to the second foot locating surface when the stand is installed onto the mat, a second antirotation feature of the mat upwardly extending from the general upper surface of the mat, the second antirotation feature disposed adjacent the second end of the second foot locating surface so as to intersect the second arc and prevent rotation of the stand around the axis in a second angular direction opposite the predetermined angular direction, interaction of the first foot locating surface with the first mat locating surface and the second foot locating surface with the second mat locating surface preventing lateral displacement of the stand relative to the mat in any direction.

15. The system of claim 14, wherein the first mat locating surface is angularly spaced from the second mat locating surface and wherein the first foot locating surface is angularly spaced from the second foot locating surface.

16. The system of claim 15, wherein the first mat locating feature is a first rib and the second raised feature is a second rib, the first and second ribs being spaced apart from each other in a transverse direction and being concavely arcuate relative to the axis; and wherein
a vaulted surface of the mat is disposed upwardly relative to the general upper surface of the mat, the vaulted surface extending between the first and second ribs and being convexly vaulted in a front-to-rear direction orthogonal to the transverse direction.
